(19) United States
(12) Patent Application Publication
(10) Pub. No.: US 2011/0025031 A1
(43) Pub. Date: Feb. 3, 2011

(54) Airbag module for a motor vehicle

(75) Inventors: Björn WINDHAUSEN, Goldbach (DE); Christian SCHREIBER, Ahrensfelde (DE); Michael HÄNSEL, Ahrensfelde (DE); Sascha PFEIFER, Berlin (DE)

Correspondence Address: FOLEY AND LARDNER LLP;SUITE 500, 3000 K STREET NW, WASHINGTON, DC, 20007, US

(73) Assignee: TAKATA-PETRI AG

(21) Appl. No.: 12/805,866

(22) Filed: Aug. 20, 2010

Related U.S. Application Data
(63) Continuation of application No. PCT/EP2008/067832, filed on Dec. 18, 2008.
(60) Provisional application No. 61/129,107, filed on Jun. 5, 2008.
(60) Provisional application No. 61/129,106, filed on Jun. 5, 2008.

(30) Foreign Application Priority Data
Feb. 21, 2008 (DE) 10 2008 010 740.9
Apr. 30, 2008 (DE) 10 2008 022 342.5

(51) Int. Cl. B60R 21/26

(52) U.S. Cl. 280/741

(57) ABSTRACT

An airbag module for a motor vehicle is provided. The airbag module comprises an airbag, which is inflatable with gas to protect an occupant, a gas generator for generating the gas provided for inflating the airbag, and an additional cooling device, which comprises a reservoir for storing a coolant. The reservoir being designed to be opened, such that the coolant may come into contact with the gas used to inflate the airbag to cool said gas. The coolant comprises at least one propanediol. The inflated airbag defines an interior of the airbag that has a volume, wherein the cooling device is adapted to inject between 0.15 and 1.00 ml coolant per liter of the volume of the airbag into the interior of the airbag.

### CROSS-REFERENCE TO RELATED PATENT APPLICATIONS

This application is a Continuation of International Application PCT/EP2008/067832, filed Dec. 18, 2008, which was published on Aug. 27, 2009 as WO 2009/103380A1. The foregoing international application is incorporated herein by reference in its entirety.

### BACKGROUND

The invention relates to an airbag module for a motor vehicle and a method for cooling a gas used to inflate an airbag in an airbag module for a motor vehicle by means of a coolant.

An airbag module is known from DE 10 2006 010 953 A1 in which a coolant is used in a cooling device for cooling a gas to be used to inflate an airbag. However, the coolant is not specified in any greater detail.

A gas generator with integral cooling device is known from WO 2007/141 335 A1, on which glycol (ethylene glycol, 1,2-ethanediol) is used as coolant. 1,2-Ethanediol does have unfavorable toxicological properties, however.

DE 22 36 380 A1 reveals the use of water and aqueous solutions of salts as coolant in gas generating devices.

The use of liquid halogenated hydrocarbons such as Freon 11 (trichlorofluoromethane) and Freon 12 (dichlorodifluoromethane) is also known from DE 21 53 639 A1. Halogenated hydrocarbons have unfavorable environmental properties, however.

### SUMMARY

It is an object of the present invention to provide an airbag module for a motor vehicle in which a coolant with favorable toxicological and particularly environmental properties is used.

An airbag module for a motor vehicle comprises an airbag which is inflatable with gas to protect an occupant. In addition, in the airbag module there are provided a gas generator to generate the gas provided to inflate the airbag and an additional cooling device, which comprises a reservoir for storing a coolant, which reservoir can be an openable reservoir. The reservoir may be opened, for example on or after inflation of the airbag, such that the coolant can come into contact with the gas used to inflate the airbag to cool said gas.

According to an exemplary embodiment of the invention, the coolant comprises at least one cooling substance, possible cooling substances being monohydric alcohols (monools) and/or polyhydric alcohols (polyols, which bear two, three or more hydroxyl groups) and/or esters and/or ethers and/or alkanes and/or alkenes and/or alkynes and/or mineral or partially synthetic or synthetic oils. The oils may be present in blended or unblended form. Blended oils are also known as additivized oils, i.e. they are combined with one or more additives. In addition, it is possible that the alkanes, alkenes and/or alkynes may be substituted and/or interrupted by one or more oxygen, nitrogen and/or sulfur atom. The coolant may comprise any desired combination of the above-stated cooling substances. Particularly, it is also within the scope of the present invention not to use individual substances of the above-stated substances as a cooling substance, such that the substances to be used as a cooling substance for the coolant are reduced to a correspondingly smaller number. In particular, provision may also be made to use water as a further cooling substance in addition to the cooling substance, i.e. to use a mixture of water and at least one further cooling substance as coolant.

According to an exemplary embodiment of the invention, it is provided that the coolant comprises at least one propanediol and the inflated airbag defines an interior of the airbag that has a certain volume, wherein the cooling device is adapted and provided to inject between 0.15 and 1.0 ml coolant for each liter of the airbag volume into the interior of the airbag in order to cool the gas therein.

Possible propanediols include, for example, 1,2-propanediol and 1,3-propanediol, with, in particular, the use of 1,2-propanediol being provided. Mixtures of 1,2-propanediol and 1,3-propanediol are also conceivable.

In order to keep the use of the propanediol material as low as possible and at the same time to ensure that the coolant has good viscosity properties, in one variant the coolant comprises a mixture of 1,2-propanediol and water. It is provided here in one variant that the coolant is exclusively composed of water and 1,2-propanediol (propyleneglycol, C3H8O2).

In one exemplary development, the mass ratio of 1,2-propanediol to water is approx. 0.5 to approx. 5, in particular approx. 0.75 to approx. 3 and very particularly approx. 1 to approx. 2.5. In these mixture ratios, mixtures of polypropyleneglycol and water which can be used particularly readily can be produced, said mixtures having a sufficiently low freezing point and not being too viscous and at the same time readily vaporizing when they come into contact with a hot gas. Basically, the vaporization of the coolant, for which purpose enthalpy of vaporization has to be applied, causes energy to be extracted from the hot gas which serves as the energy provider. That is to say, the vaporization of the coolant cools the hot gas which is used to inflate the airbag. In this case, mixtures of 1,2-propanediol and water require a sufficient quantity of enthalpy of vaporization such that the desired cooling effect occurs in a favorable manner.

In a further exemplary development it is provided that a further substance for lowering the freezing point of the coolant is used. In this case the coolant can be composed of at least two substances if no water is used and of at least three substances if water is also contained in the coolant. Particularly, in this case, it is possible in one variant—depending on the quantity of further substance added for lowering the freezing point—to lower the proportion of propanediol or a corresponding substance in the coolant to a very low value or to even allow it to drop toward zero (when propanediol is used as a coolant). The further substance for lowering the freezing point may serve to maintain a liquid state of aggregation of the coolant even at temperatures which lie significantly below the freezing point of pure water. The coolant and consequently the entire airbag module therefore remain operable even at low temperatures, such as prevail, for example, during winter. At the same time, the further substance for lowering the freezing point should be selected to the effect that it does not substantially affect vaporization of the remaining substances of the coolant and, if appropriate, can itself easily be vaporized. The further substance should also have similarly good toxological properties to the propanediol (or an alternative substance of the coolant) used in order to keep the effects of skin contact or inhalation of aerosol, which is in principle possible after an airbag is triggered, to a level which is not damaging to the health of the vehicle occupant.

In one exemplary variant, the coolant comprises at least one additive in addition to the cooling substance, that may be an emulsifier or a surfactant or a foam inhibitor or a substance for reducing or preventing mist formation on vaporisation of the coolant.

The additive (further substance) may also be a biocide. Examples of biocides are fungicides, bactericides, algicides, microbicides and virucides. Mixtures of the above-stated additives are likewise conceivable. The additive may also be selected from a group which constitutes a sub-combination of the above-stated classes of substances or the substances contained therein.

Suitable substances for lowering freezing point are sugars or sugar substitutes.

In this respect, in one exemplary variant, a sugar or a sugar substitute is used as the further substance for lowering the freezing point. Sugar or sugar substitutes can generally be classified as toxicologically favorable since they are also used as food additives.

It is possible, for example, to use sucrose, sorbitol, xylitol, maltitol, lactitol, isomalt, fructose, erythritol, cyclamate, glucose and/or Acesulfame K as sugar or sugar substitute. Mixtures of these substances are likewise possible.

The additive (further substances) may also be adapted for protecting those parts of the airbag module from corrosion, that can come into contact with the coolant, especially the reservoir and/or a nozzle of the reservoir.

The freezing point of the coolant is lowered in relation to the freezing point of pure water both by means of the coolant (for instance propanediol) used and, if appropriate, by the further substance used for lowering the freezing point. In one variant here, the freezing point of the coolant is at or below approx. −40° C., in particular at or below approx. −38° C., in particular at or below approx. −35° C. and very particularly at or below approx. −30° C. This ensures that, even at low external temperatures, the operability of the airbag module or the efficiency of the cooling of the escaping hot gases is not affected.

When the coolant vaporizes as a consequence of contact with the hot gases which are generated to inflate the airbag, a mist formation may in principle occur. In order to keep said mist formation to as low a level as possible or even to entirely avoid it, in one development of the airbag module an additive for reducing or avoiding mist formation is added to the coolant (see above). An example of a suitable additive of this type is a mixture of polyethylene glycol and silicon dioxide, in particular with more than 95% by weight of polyethylene glycol and less than 3% by weight of silicon dioxide, for example as known under the trade name POLYOX™ WSR 301.

To make use of the coolant safe, in one variant the cooling substance has properties such that inhalation of the cooling substance, for example if the coolant containing the cooling substance is vaporized, by a vehicle occupant is toxicologically safe. Consequently, corresponding vaporization of the coolant must not result in formation of any toxic compounds from the cooling substance. The cooling substance must not in itself exhibit toxic properties, either. Inhalation of the cooling substance or of the coolant may be deemed to be toxicologically safe provided limit values prescribed by legislation or a special interest group or a comparable organization are not exceeded.

In a further exemplary development, in addition to the cooling substance, the coolant comprises a gas in dissolved form. It is thereby possible, upon opening of the reservoir, which stores the coolant, and upon concomitant modification of the pressure acting on the coolant, to achieve outgassing of the gas dissolved in the coolant. In addition, by increasing the temperature of the coolant as a consequence of the process of cooling the gas used to inflate the airbag, a further physical possibility is provided for achieving outgassing of the gas contained in dissolved form in the coolant. In the process, outgassing of the gas previously contained in dissolved form in the coolant may take place suddenly or abruptly, such that swirling of the coolant occurs. This brings about better dispersion of the coolant and thus more effective cooling of the gas used to inflate the airbag, i.e. a metastable state of the coolant is provided in one development of the invention due to the presence of a readily outgassable gas in dissolved form.

In one exemplary variant, the gas present in dissolved form in the coolant is carbon dioxide (CO2).

In order to achieve particularly effective cooling of the gas used to inflate the airbag, in one development the coolant is substantially liquid at room temperature. It may be present, for example as a solution, emulsion or dispersion. A liquid pure substance is also provided as coolant for the purposes of the present invention. In order to allow good usability of the coolant under constant conditions, when the coolant consists of a mixture of more than one substance, it is always so formulated that the individual constituents of the coolant do not segregate. If the coolant contains water and oil for example, the addition of an emulsifier or of a surfactant to maintain a stable emulsion of the oil in water is advantageous, in order to counteract segregation of the two substances. Suitable additives allow the provision of a stably storable coolant. Certain substances, which are miscible together in any desired ratio, do not require any additives in order to counteract segregation of these substances. This depends on the respective individual properties of the substance to be used as cooling substances.

If the coolant is in liquid form, it vaporizes on contact with the hot gas used to inflate the airbag. For transition from the liquid to the gaseous state of matter, enthalpy of vaporization is required, which draws a large amount of energy from the hot gas. In this way, particularly efficient cooling of the gas used to inflate the airbag is achieved.

It is advantageous in this respect for the coolant to be present in the range from approx. −40° C. to approx. +90° C. (for individual areas of application also up to approx. +107° C.) in the liquid state of matter. In addition to a freezing point of the coolant of approx. −40° C., a freezing point is also provided of approx. 38° C. or below, in particular of approx. −35° C. or below, and very particularly of approx. −30° C. or below.

Likewise, in addition to a boiling point of the coolant of approx. +90° C., a boiling point is also provided for the coolant of approx. +95° C. or above, in particular of approx. +100° C. or above, in particular of approx. +105° C. or above and very particularly of approx. +107 C or above.

In one exemplary variant, the cooling substance used has the same freezing and boiling points as the coolant. In this case, the phase transition points of the cooling substance need not then be influenced by additives.

With a boiling point just above the upper limit of the temperature range within which standard use is made of the airbag module (this is conventionally a temperature of approx. +90° C.), particularly simple vaporization of the coolant may proceed when it comes into contact with the gas to be cooled which is used to inflate the airbag. If the boiling point of the coolant is for example between approx. 90° C. and approx. 100° C., vaporization of the coolant occurs in any case upon contact with the hot gas used to inflate the airbag, and energy is thus removed from the gas used to inflate the airbag.

In one exemplary variant, the coolant is formulated to be non-flammable if oxygen is excluded from the system. In a further variant, it is also non-flammable when it is finely atomized and comes into contact with a hot gas which is used to inflate the airbag. This gas generally has a low oxygen content, for which reason numerous types of oil which may be used should also be regarded as non-flammable when finely atomized with the gas used to inflate the airbag.

In order to enable a particularly fine dispersion of the coolant in the gas to be cooled, in one variant the coolant has a surface tension at +20° C. of less than or equal to 150 mN/m, in particular of less than or equal to 100 mN/m, in particular of less than or equal to 50 mN/m and very particularly of less than or equal to 25 mN/m.

In a further exemplary development of the invention, the surface tension of the coolant is lower than the surface tension of pure water under the same conditions. In any event, this allows the coolant to be more readily dispersed in comparison with dispersing pure water.

Particularly, the cooling device is adapted to inject between 0.15 and 0.45 ml coolant per liter (l) of the airbag volume into the interior of the airbag in case the occupant occupies the seat in an intended manner. This normal seating position is to be distinguished from a so-called out-of-position situation, where the occupant is too close to the airbag and thus the risk for becoming injured due to the deploying airbag is high. In the latter situation (out-of-position situation) the cooling device is adapted to inject between 0.7 and 0.1 ml coolant per liter (l) of the airbag volume into the interior of the airbag in order to decrease the pressure in the interior of the airbag very fast.

In order to detect the position of the occupant, the distance between a body part of the occupant, for instance the head or torso of the occupant, and the airbag may be detected by a sensor. This sensor can be coupled to the cooling device, particularly to a controlling unit of the cooling device, that is configured to activate (operate) the cooling device depending on the (sensed) position of the occupant such that the above described amounts of coolant are injected into the interior of the airbag.

With respect to said distance, an out-of-position situation occurs in case the distance between said body part of the occupant and the airbag (in an not-inflated state) is below a certain pre-defined minimal distance.

In a method according to en exemplary embodiment of the invention, an airbag in an airbag module for a motor vehicle is inflated by a gas which is cooled by means of a coolant contained in a cooling device. In this case, the cooling device comprises a reservoir for storing the coolant that may be openable, the reservoir being opened for example during or after deployment of the airbag, such that the coolant for cooling the gas used to inflate the airbag comes into contact with this gas. The invention here provides that the coolant comprises at least one cooling substance, which is a monohydric alcohol, a polyhydric alcohol, an ester, an ether, an alkane, an alkene, an alkyne and/or a blended or unblended mineral, partially synthetic or synthetic oil. Mixtures of the above-stated substances are likewise conceivable. The above-stated method also comprises the use of a sub-combination of the above-stated substances as a cooling substance. In addition, it is possible for the alkanes, alkenes and/or alkynes to be substituted and/or interrupted by one or more oxygen, nitrogen and/or sulfur atoms.

In one embodiment, it is provided that the coolant comprises at least one propanediol.

According to one exemplary variant of the method according to the invention, the inflated airbag defines an interior of the airbag that has a volume, wherein between 0.15 and 0.45 ml coolant per liter (l) of the airbag volume are injected into the interior of the airbag by the cooling device in order to cool the gases therein, when the occupant is seated in an intended (normal) position, while the cooling device is configured to inject between 0.7 ml and 1.0 ml coolant per liter volume of the airbag into the interior of the airbag in case the occupant is out of position. The position of the occupant may be detected by a sensor that detects the distance between a body part of the occupant, say the head or torso of the occupant, and the (not inflated) airbag. A so-called out-of-position situation is given in case said distance is below a certain pre-defined minimal distance, for instance in case the occupant is bent towards the airbag.

With regard to further variants or developments of the method, reference is made to the above explanations of variants and developments of the airbag module, which likewise relate in a similar manner also to the claimed method.

The invention additionally relates to the use of a monohydric alcohol, of a polyhydric alcohol, of an ester, of an ether, of an alkane, of an alkene, of an alkyne and/or of a blended or unblended mineral, partially synthetic or synthetic oil and mixtures of the above-stated substances as a cooling substance of a coolant for cooling a gas used to inflate an airbag in an airbag module for a motor vehicle. It is possible in this respect that the alkanes, alkenes and alkynes may be substituted and/or interrupted by one or more oxygen, nitrogen and/or sulfur atoms.

In particular, the invention additionally relates to the use of a propanediol as coolant for cooling a gas which is used to inflate an airbag in an airbag module for a motor vehicle.

In one variant, the coolant is here contained in a cooling device which comprises a reservoir for storing the coolant, the reservoir being designed so as to be opened, such that the coolant for cooling the gas used to inflate the airbag may come into contact with this gas.

With regard to further variants or developments of the use of the above-stated substances as a cooling substance, reference is made to the above explanations relating to variants and developments of the airbag module which also apply likewise to the claimed use.

### BRIEF DESCRIPTION OF THE DRAWINGS

Further details of the invention will be explained with reference to exemplary embodiments illustrated in the figures, in which:

FIG. 1 shows a schematic sectional view through an airbag module.

FIG. 2 shows the amount of coolant in ml that is injected into the interior of the airbag per liter volume of the airbag.

### DETAILED DESCRIPTION

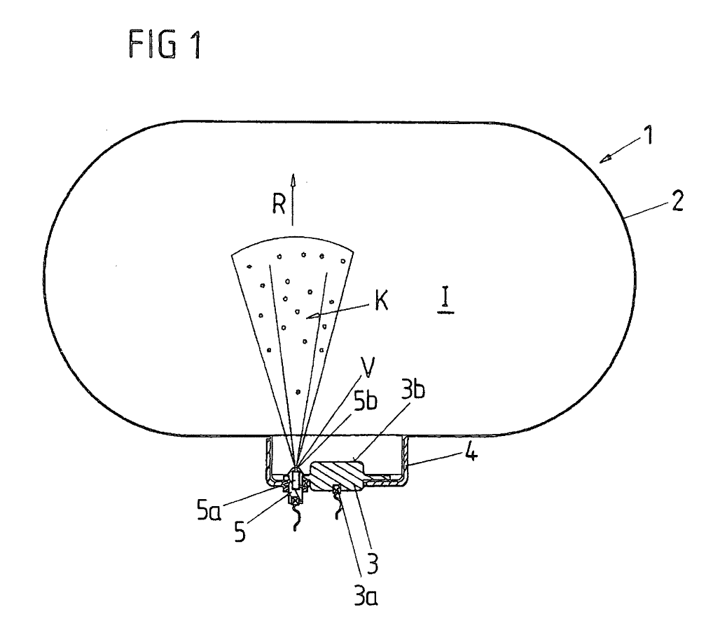

FIG. 1 shows a schematic sectional view of an airbag module 1, which comprises an airbag 2, which is inflatable to protect a person, and a gas generator 3, which provides the gas needed to inflate the airbag 2. To this end, the gas generator 3 comprises a detonator 3a, which may be actuated by means of control electronics in the vehicle. The airbag 2 and the gas generator 3 of the airbag module 1 are fixed to a generator support 4, together with a cooling device 5 arranged adjacent the gas generator 3, which serves to cool the gas used to inflate the airbag 2.

The section plane of the airbag module 1 shown in FIG. 1 extends—relative to a situation in which the airbag module 1 is installed in a steering wheel—parallel to a steering axle of the steering wheel (not shown).

The airbag 2 comprises an inflow opening, through which the gas from the gas generator 3 may be introduced into the interior I of the airbag 2 to inflate the airbag 2.

The cooling device 5 comprises a reservoir 5a for storing a coolant K which is liquid in the operating temperature range of the airbag module (from approx. +85° C. to approx. −40° C.), which coolant K may pass through an outflow opening 5b into the interior I of the airbag 2. The coolant K here comprises at least one cooling substance, which is selected from the group comprising monohydric alcohols, polyhydric alcohols, esters, ethers, alkanes, alkenes, alkynes and blended or unblended mineral, partially synthetic or synthetic oils. Particularly the coolant K may be a mixture of water and 1,2-propanediol (propylene glycol). When this coolant is vaporized, a toxicologically safe vapor arises, such that even in the event of skin contact with this vapor or oral intake of the vapor or of a corresponding aerosol, no harmful consequences are to be anticipated for a vehicle occupant.

The outflow opening 5b takes the form of a nozzle, such that, when the coolant K is introduced from the reservoir 5a through the outflow opening 5b in an outflow direction R into the interior I of the airbag 2, it is atomized, i.e. subdivided into small droplets.

Various methods known from the prior art may be used to force the coolant K out of the reservoir 5a of the cooling device 5. A closure V, which closes the outflow opening 5b when the airbag module has not been activated, is here always opened. This may take place for example by an overpressure generated in the reservoir 5a. It is also possible for a reversibly openable or (re)closable valve to be used as a closure V for the outflow opening 5b.

Since, at a constant volume, the pressure of the gas situated in the airbag 2 is proportional to the temperature of the gas, a reduction in the gas pressure prevailing in the airbag 2 is achieved by cooling. This means that, by means of controllable cooling of the gas situated in the airbag 2, the airbag 2 may be adapted to a specific accident situation.

The cooling effect arises in that the coolant K is atomized and vaporized by the hot gas situated in the interior I, the temperature of the gas being lowered since energy has to be applied to convert the liquid phase of the coolant into the gaseous phase, i.e. to provide the required enthalpy of vaporization.

In principle, the widest possible range of airbag designs is feasible, in which a coolant which comprises at least one propanediol may be used.

Various examples of possible coolant compositions are illustrated below in table form.

TABLE 1
Various mixtures of 1,2-propanediol and water which are
suitable for use as a coolant in an airbag.

| Example | Water/g | 1,2-propanediol/g | Freezing point |
|---|---|---|---|
| 1 | 3.3 | 6.7 | −40° C. |
| 2 | 3.6 | 6.4 | −38° C. |
| 3 | 4.0 | 6.0 | −35° C. |
| 4 | 5.0 | 5.0 | −30° C. |

These water-1,2-propanediol mixtures each constitute 10 g of a coolant. In this case, the mass of 10 g is to be understood only as an example; a corresponding airbag module can also in each case contain a greater or lesser amount of coolant.

TABLE 2
Examples of water-1,2-propanediol-sugar mixtures which are suitable as
coolant in an airbag module.

| | | | | Freezing |
|---|---|---|---|---|
| Example | Water/g | 1,2-propanediol/g | Sugar | point |
| 1 | 3.9 | 1.5 | 4.6 | −40° C. |
| 2 | 3.7 | 0.7 | 5.6 | −35° C. |

The examples of water-1,2-propanediol-sugar mixtures illustrated in Table 2 each also involve 10 g of a coolant, with it also being possible for a greater or a lesser amount of a coolant to be used in an airbag module. Suitable examples of the sugar include the sugar and sugar substitutes listed further above, wherein the sugars are to be as soluble as possible in water so that the coolant constitutes a homogeneous liquid mixture which is free from solids.

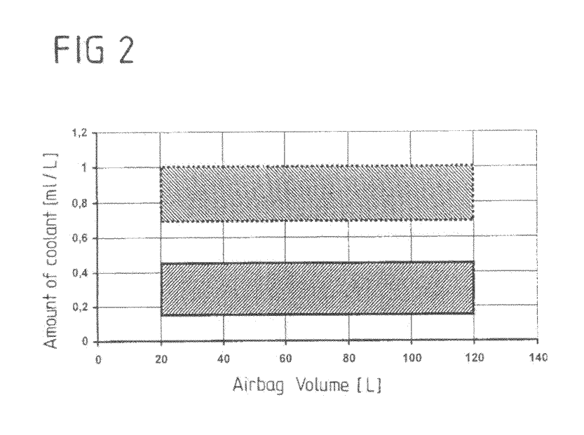

FIG. 2 shows a graph that depicts the amount of coolant in ml which the cooling device 5 injects into the interior I of the airbag 2 per liter (abbreviated as L in FIG. 2) of the volume of the airbag 2. This volume is the volume of the interior I of the airbag 2 that is defined by the airbag 2.

The box in FIG. 2 having a solid outline corresponds to the amount of coolant in ml that is injected into the interior I of the airbag 2 in case the occupant is seated in an intended normal position, where, for instance, the back of the occupant abuts a backrest of the seat occupied by the occupant. In this case between 0.15 ml and 0.45 ml coolant per liter (abbreviated as L in FIG. 2) of the airbag volume are injected into the interior I of the airbag 2. For example, an airbag 2 having an airbag volume of 100 l will be cooled with an amount of coolant between 15 ml and 45 ml.

The box in FIG. 2 having a dotted outline corresponds to the amount of coolant in ml that is injected into the interior I of the airbag 2 in case the occupant is out-of-position as defined above. In this case, between 0.7 ml and 1.0 ml coolant per liter of the airbag volume are injected into the interior I of the airbag 2. For example, an airbag 2 having an airbag volume of 100 l will be cooled with an amount of coolant between 70 ml and 100 ml.

U.S. Provisional Application Nos. 61/129,107 and 61/129,106, filed Jun. 5, 2008, respectively, are incorporated herein by reference in their entirities. German Priority Application No. 10 2008 010 740.9, filed Feb. 21, 2008 and German Priority Application No. 10 2008 022 342.5, filed Apr. 30, 2008, including the specification, drawings, claims and abstract, are incorporated herein by reference in their entirities.

What is claimed is:

1. An airbag module for a motor vehicle, having
an airbag, which is inflatable with gas to protect an occupant,
a gas generator for generating the gas provided for inflating the airbag, and
an additional cooling device, which comprises a reservoir for storing a coolant, the reservoir being designed to be opened, such that the coolant may come into contact with the gas used to inflate the airbag to cool said gas, wherein the coolant comprises at least one propanediol and the inflated airbag defines an interior of the airbag that has a volume, wherein the cooling device is adapted to inject between 0.15 and 1.00 ml coolant per liter of the volume of the airbag into the interior of the airbag.

2. The airbag module according to claim 1, wherein the propanediol is 1,2 propanediol.

3. The airbag module according to claim 2, wherein the coolant comprises a mixture of 1,2-propanediol and water.

4. The airbag module according to claim 3, wherein the mass ratio of 1,2-propanediol to water is 0.5 to 5, in particular 0.75 to 3 and very particularly 1 to 2.5.

5. The airbag module according to claim 1, wherein the coolant has at least one further substance for lowering the freezing point.

6. The airbag module according to claim 5, wherein the further substance is a sugar or a sugar substitute.

7. The airbag module according to claim 1, wherein the coolant comprises an additive for reducing or preventing mist formation during vaporization of the coolant.

8. The airbag module according to claim 1, wherein the cooling substance exhibits properties such that inhalation of the cooling substance or of the coolant by a vehicle occupant is toxicologically safe.

9. The airbag module according to claim 1, wherein the freezing point of the coolant is at or below −40° C., in particular at or below −38° C., in particular at or below −35° C. and very particularly at or below −30° C.

10. The airbag module according to claim 1, wherein the boiling point of the coolant is at or above +90° C., in particular at or above +95° C., in particular at or above +100° C., in particular at or above 105° C. and very particularly at or above +107° C.

11. The airbag module according to claim 1, wherein the inflated airbag defines an interior of the airbag that has a volume, wherein, in case the occupant is seated in an intended position, the cooling device is adapted to inject between 0.15 and 0.45 ml coolant per liter of the volume of the airbag into the interior of the airbag.

12. The airbag module according to claim 1, wherein the inflated airbag defines an interior of the airbag that has a volume, wherein, in case the occupant is out of position, the cooling device is adapted to inject between 0.7 and 0.1 ml coolant per liter of the volume of the airbag into the interior of the airbag.

13. A method of cooling a gas used to inflate an airbag in an airbag module for a motor vehicle by means of a coolant, which is contained in a cooling device, the cooling device comprising an reservoir for storing the coolant and the reservoir being opened such that the coolant for cooling the gas used to inflate airbag comes into contact therewith, wherein the coolant comprises at least one propanediol, and the inflated airbag defines an interior of the airbag that has a volume, wherein between 0.15 and 1.0 ml coolant per liter of the volume of the airbag are injected into the interior of the airbag.

14. The method according to claim 13, wherein a distance between the occupant and the airbag is detected by means of a sensor coupled to the cooling device, wherein the cooling device is adapted to inject between 0.7 and 1.0 ml coolant per liter of the volume of the airbag into the interior of the airbag in case the distance is below a certain pre-defined minimal distance

15. The method according to claim 13, a distance between the occupant and the airbag is detected by means of a sensor coupled to the cooling device, wherein the cooling device is adapted to inject between 0.45 and 0.7 ml coolant per liter of the volume of the airbag into the interior of the airbag in case the distance is equal or larger than a certain pre-defined minimal distance.
